(19) United States
(12) Patent Application Publication
(10) Pub. No.: US 2015/0183205 A1
(43) Pub. Date: Jul. 2, 2015

(54) Method for optimising flexographic negatives

(71) Applicant: Paul Mayo Holt, Phoenix, AZ (US)

(72) Inventor: Paul Mayo Holt, Phoenix, AZ (US)

(21) Appl. No.: 14/142,883

(22) Filed: Dec. 29, 2013

(51) Int. Cl. B41C 3/00

(52) U.S. Cl. CPC B41C 3/00

(57) ABSTRACT

The invention provides an improved method of imaging analogue flexographic liquid and sheet printing plates. Specifically it involves adding colour or greyscale to some of the clear parts of negatives used to make flexographic plates. This colour moderates the light allowed through the clear areas, keeping reverses open to the maximum depth possible, preventing the widening or overexposure of relief and reverse whilst allowing the maximum amount of light through the small clear areas making the fine relief. It does this by calculating the correct amount of light for each part of the negative according to the predicted amount of light that will be transmitted through it, adjusting the intensity of colour accordingly. It provides a technical advantage of using a negative over the digital process, widening the amount of information available to create the printing plate from just black and white. It enables the plate maker to achieve an optimal printing plate independent of design. The incorporation of a half tone screen over the selective colour enhances total ink delivered. The screen can also level out intensity irregularities in intensities in the exposure units.

### FIELD OF THE INVENTION

This invention describes an innovative system for improving the imaging of analogue flexographic printing plates. Specifically it involves selectively adding colour or greyscale to the translucent areas of a negative to reduce the radiation transmitted through them to achieve optimal exposure for both large and small areas of reverse and relief.

### BACKGROUND OF THE INVENTION

A flexographic printing plate is a binary printing device that will either deliver ink or not. In the preparation of the printing plate both sheet and liquid analogue systems use a conventional negative that has both black and clear parts. The black part(s) of the negative prevent the transmission of curing radiation (e.g. UV light) and the uncured photopolymer in the areas under them can subsequently be removed to create a 3 dimensional printing plate from the 2 dimensional negative.

Liquid polymerisable resin compositions comprise a prepolymer which has at least one polymerisable double bond, an ethylenically unsaturated monomer having at least one polymerisable double bond and a photopolymerisation initiator. Typically, the photopolymer composition contains also a light absorber and a polymerisation inhibitor as a stabiliser against premature polymerisation. As suitable prepolymers there may be mentioned unsaturated polyester resins, unsaturated polyurethane resins, unsaturated polyamide resins, unsaturated polyacrylate resins and unsaturated polymethacrylate resins, especially polyether-polyester urethane copolymer, polyether urethane polymer and hydroxyl terminated hydrogenated polybutadiene resin. Polyether urethane or polyester-polyether urethane based photopolymer compositions are very suitable.

The term “solid photopolymer” as used herein excludes photopolymers which are liquid at room or ambient temperature. Solid photopolymer used in the present methods, products and compositions is a photopolymer which is a solid up to about 50° C. prior to curing but which may be a liquid at temperatures above about 50° C. (pre-curing).

Examples of solid photopolymers which can be used in the present invention include those which are produced from, for example, unsaturated polyester resins, unsaturated polyurethane resins, unsaturated polyamide resins and unsaturated poly(meth)acrylate resins, for example polyether urethane polymers, polyether polyester urethane copolymers e.g. polyether polyester urethane methacrylate.

The trend in the production of flexographic printing plates over the last 10 years has been to replace analogue systems, which generate their images from negatives, with digital processing, where the image is transferred directly from computer to plate. This invention provides a significant benefit in favour of the use of negatives over digital methods in that negatives can now hold more information than just a binary choice for each pixel, and this information can improve the quality of the resultant printing plate.

Plate production using liquid photopolymer compositions is in decline for a number of reasons; the results from it are more variable, the discharge of the liquid composition requires greater technical ability and there is no commercially available digital offering. Two benefits that liquid photopolymer compositions have over those in the form of a sheet are that liquid compositions are available in softer grades, providing durometers as low as 18 Shore A which are necessary to achieve good ink coverage on lower cost more fluted corrugated board, and that it enables resin recovery of unused polymer composition making it cheaper to use. Liquid systems are currently all analogue.

Thus, areas that deliver ink in a flexographic printing plate are composed of four categories:
a) Intended full plate height relief created by clear areas surrounded by black on the negative.
b) Intended full plate height reverse created by black areas surrounding clear on the negative.
c) Areas of reverse and relief that unintentionally deliver ink caused by compression as a consequence of printing plate pressure and the durometer (compressibility) of the polymer. These are unintended, undesirable and cause what is known as dot gain.
d) Areas of reverse and relief that unintentionally deliver ink caused by over exposure as a consequence of too much exposure light widening the image. These are unintended and undesirable.

Someone expert in the industry can reduce the over exposure effects stated in d) above by reducing the main exposure to the point that the relief is only just made satisfactorily. This is a difficult point to achieve in practice and on certain negatives on some machines it is impossible not to overexpose the reverse, and consequently increase the size of the inked image it delivers, while maintaining strong fine relief.

As already indicated, photopolymer is typically cured by ultraviolet light in the preparation of flexographic printing plates. The use of alternative wavelengths of radiation is not excluded and the following discussion for convenience refers to UV as a shorthand designation for curing radiation of any wavelength.

This invention thus overcomes or mitigates one of the most fundamental problems in flexographic printing, namely obtaining optimal printing plate performance for images for which it is currently difficult if not impossible to achieve optimal exposure, i.e. those images which are formed from negatives that have an area that are largely clear and an area that is largely black. Examples of such negatives are standard test negatives which are used to test the quality of the polymer, negative, exposure unit and exposure times. Test negatives have large areas of clear material, which enables a lot of UV transmission, with small black images inset in them creating fine reverse print, juxtaposed with large areas of black, heavily restricting UV transmission, with small clear images inset in them creating fine relief print.

This invention adjusts the transmission of UV across the negative in relation to its design and reduces or eliminates the errors stated in d) above.

Flexographic printing plates typically have relief created by areas of the negative with very small areas of clear image surrounded by black, allowing very little UV light through and therefore requiring long exposure times. These times are particularly long when creating very fine images such as 4 point text or smaller. Printing plates also typically have areas of reverse that are created by small areas of black surrounded by large areas of clear. The reverses in these parts require shorter exposure times than the relief because they allow a lot more UV light through.

Furthermore, large sized reverses allow more light through than small ones enabling the polymer to cure quicker and thus larger reverses require shorter exposure times than smaller ones.

Furthermore, clear areas of the negative that produce small sized relief have an optimal exposure time that is considerably longer than clear areas that produce large sized relief, for the same reason.

It is well known in the industry that optimal exposure times are a function of the design on the negative. The reason for this is that light is not directed vertically at the negative, but floods through the open areas at angles approaching horizontal to the exposure glass. If the light from the exposure bulbs could be directed vertically, at right angles to the negative, then there would be no difference in exposure between the areas of a flexographic printing plate created by large or small areas of clear negative as they would all receive the same amount of light.

Unfortunately it is a drawback of all exposure units that the light is not coherent. The banks of tubes emit light at all angles and that light is then bounced of walls and other tubes. It is the light entering the negative at an angle other than vertical that creates the problem of over exposure.

On a negative an area of clear surrounded by black allows light through to polymerise the polymer directly above it, but also allows light at all angles adding to the polymerisation of the neighbouring polymer. This cumulative effect means that every different area of clear on a negative has a specific optimal exposure time, and this time is a function of the clear area's size and shape.

The exposure window between underexposure and overexposure is called the exposure latitude and is calculated as the main exposure time that comes closest to maintaining both fine reverse and fine relief on the same plate. In practice it is harder to detect overexposure than underexposure and plates with both fine reverse and fine relief tend to be overexposed.

An innovative technical solution to the effect of overexposure has been described in U.S. Pat. No. 5,147,761, issued Sep. 15, 1992, to Wessells et al. herein incorporated by reference in its entirety, which involves positioning a louver, or collimator, having a plurality of open cells having a reflective surface over an image-bearing photographic negative which, in turn, is positioned over a photocurable material. The idea of using collimators was developed further by Varnard in WO2001014930 A1 herein incorporated by reference in its entirety.

Collimating filters reduce overexposure in reverses by eliminating the light that enters the polymer through the negative at angles substantially greater than 30 degrees to the vertical. In areas of reverse the small areas of black on the negative are surrounded by clear areas which allow the light to enter from wide angles, and collimating filters are successful at reducing this light and consequently maintaining the openness of the reverses. One drawback of using collimating filters is that they reduce the overall light transmitted throughout the entire plate and consequently extend the necessary exposure times, typically doubling them. This invention leaves the exposure time of the plate unchanged at the optimised time to make the finest relief.

The present invention addresses the problem of the creation of areas of the printing plate that unintentionally deliver ink due to overexposure. Overexposure could be overcome with a selective filter that reduces the light through the larger clear parts in proportion to their size, while not correspondingly reducing light transmission through the smallest clear parts, preferably allowing maximum light to be transmitted through the smallest clear parts. This invention achieves differential reduction of light through clear areas of differing size by making the amount of light transmitted at each point a function of the amount of clear area on the negative surrounding it. Using this invention plates can be exposed so that they achieve favourable exposure for all areas, both relief and reverse, both fine and small, at a single optimised time. This time is always the time required to make the finest relief on the negative.

### STATEMENT OF THE INVENTION

According to a first aspect of this invention is provided a method of making a photopolymer printing plate, the method comprising exposing a photopolymer composition to curing radiation through a negative comprising a translucent portion and an opaque portion, wherein the translucent portion of the negative is selectively provided with a shaded area which is not opaque but which reduces the amount of radiation that passes through to the photopolymer composition as compared to a corresponding non-shaded area to reduce or eliminate unintended exposure to curing radiation of photopolymer intended to be removed uncured.

According to a second aspect of the invention is provided a method of making a negative for use in the production of a photopolymer printing plate, wherein the negative comprises a translucent portion and an opaque portion, the method comprising selectively providing the translucent portion of the negative with a shaded area which is not opaque but which, when the negative is used in the exposure of a photopolymer composition to curing radiation, reduces the amount of radiation that passes through to the photopolymer composition as compared to a corresponding non-shaded area to reduce or eliminate unintended exposure to curing radiation of photopolymer intended to be removed uncured.

The shaded areas of the translucent sections of the negative reduce the amount of radiation which passes through those areas. This shading thus allows the appropriate exposure time to gain favourable and ideally optimal resolution for small clear areas in the negative, without allowing too much radiation through the large clear areas and thus increasing their printable areas.

The translucent portion of the negative may be shaded by selectively providing it with a partially radiation-blocking greyscale tint. Alternatively (or additionally), the translucent portion of the negative may be shaded by selectively providing it with a partially radiation-transmitting colour tint.

The negative may comprise the shaded areas. Thus, the shaded areas may be printed onto the negative substrate at the same time as the image. The negative may be produced by a laser printer. The negative may be produced by an inkjet printer. Most modem printers, and particularly inkjet printers, have the capacity to print in colour as well as in black and white.

Alternatively, a film which comprises the shaded area(s) may be positioned such that the shaded area(s) and the negative area(s) to be shaded overlie one another, e.g. the film may be located between the negative and the source of curing radiation. In this case, the negative may be made by any means known in the art, e.g. by printing or by using development techniques (e.g. an imagesetter apparatus). The film comprising the shaded areas will typically be produced by printing, e.g. using an inkjet printer. Because there is such flexibility in how to provide the negative with the shaded areas, the invention is compatible with any current production system for analogue flexographic printing plates.

The shaded areas may be shaded to an intensity which is in proportion to their size and shape. It may be that a computer algorithm calculates the intensity of shading to be applied at each point of the translucent portion of the negative in proportion to the amount of curing radiation transmitted through the negative at those points.

The computer algorithm may also adjust for variation in the intensity of the curing radiation transmitted from the different portions of the source of curing radiation.

The photopolymer composition may be in the form of a liquid. Alternatively, the photopolymer composition may be in the form of a sheet or a solid.

The shading in the shaded area may be composed of a plurality of dots. This creates a pitted or otherwise surface on those portions of the printing plate which are in relief and can lead to a printing plate which transfers solid ink more effectively. This is believed to be because more ink is stored on the relief portions of the printing plate if the surface is rough or pitted.

Viewed from another aspect, there is provided a computer-implemented method of determining a shading pattern to be applied to a negative for use in the production of a photopolymer printing plate, the negative comprising translucent portions and opaque portions, wherein the method comprises scanning the negative, defining an array of pixels of predetermined size for each of the translucent portions, determining an amount of light that that will be transmitted through each pixel from a predetermined light source, and calculating a degree of shading that is to be applied to each pixel so as optimise an overall exposure of the photopolymer printing plate by the predetermined light source through the negative, the degree of shading being a function of the amount of transmitted light.

The degree of shading for each pixel may be proportional to the amount of light determined to be transmitted through that pixel. A centre of mass for each translucent portion of the negative may be determined, and a greater degree of shading may be calculated for pixels at or close to the centre of mass than for pixels remote from the centre of mass.

The degree of shading for each pixel may be determined by summing all of the adjoining translucent pixels to it, each one multiplied by a weighting factor inversely proportional to a distance of that pixel from the centre of mass.

Viewed from another aspect, there is provided a computer program for instructing a computer to perform the method of the preceding aspect.

### BRIEF DESCRIPTION OF THE DRAWINGS

Embodiments of the invention are further described hereinafter with reference to the accompanying drawings, in which:

FIG. 1 shows a flexographic plate with a well-formed 0.25 mm diameter dot (relief) and well-formed 0.25 mm reverse.

FIG. 2 shows a flexographic plate with an overexposed 0.25 mm dot and an overexposed (closed) relief.

FIG. 3 shows the negatives which created the plates shown in FIGS. 1 and 2.

FIG. 4 shows the amount of light transmitted through clear circles of increasing diameters measured in mW/cm².

FIG. 5 shows an example of a negative with a coloured shaded area in the translucent portion. The colour is not evenly distributed, but has been calculated at each point by calculating the amount of translucent areas surrounding it, and adjusting the density of colour accordingly.

FIG. 6 shows the level of light transmitted through different intensities of colour filters measured in mW/cm²

FIG. 7 shows a printing plate made with exposure times that gave a well formed relief 0.25 mm dot, but at the same time closed the 0.25 mm reverse.

FIG. 8 shows a printing plate made with exposure times that gave an open 0.25 mm reverse, but at the same time lost the fine 0.25 mm dot completely.

FIG. 9 shows a printing plate made with tonally gradated negative using a maximum colour in the translucent areas of Y=100 giving both open 0.25 mm reverse and at the same time a strong 0.25 mm dot.

FIG. 10 shows a printing plate made with tonally gradated negative using a maximum colour in the translucent areas of M=100 giving both open 0.25 mm reverse and at the same time a strong 0.25 mm dot.

FIG. 11 shows a printing plate made with tonally gradated negative using a maximum colour in the translucent areas of C=100 and M=100 giving both open 0.25 mm reverse and at the same time a strong 0.25 mm dot.

FIG. 12 shows a printing plate made with tonally gradated mask laid under a negative using a maximum colour in the translucent areas of Y=100 giving both open 0.25 mm reverse and at the same time a strong 0.25 mm dot.

### DETAILED DESCRIPTION

For the avoidance of doubt, it is hereby stated that the description of the invention in this specification is to be read in the context of the disclosure under the heading “Background of the Invention”. Accordingly, subject matter disclosed under that heading may be combined with the disclosure of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Assembly of flexographic plates from liquid photopolymer compositions typically involves laying a negative down, covering it with a protective film known as a coverfilm (typically 20 my polypropylene) removing the air from between the negative and the coverfilm by applying a vacuum and discharging the photopolymer over it The photopolymer may be contained within boundary walls compressible to the plate gauge. A photoinitiator coated substrate (typically 125 my PET), known as a backing sheet, may then be laid on the top, and the upper glass of the exposure unit may then be lowered to deliver force evenly onto spacer bars defining the final plate gauge.

In the assembly of analogue (ie non-digital) sheet or solid polymer polymer composition precursors for flexographic plates, for instance the product Cyrel made by Dupont, a protective film is typically removed from the side of the polymer which will be exposed to the curing radiation, the sheet photopolymer composition may then be laid on top of the negative. Optionally, a film to enable delivery of vacuum is pulled over the assembly and vacuum is engaged to remove entrapped air.

Both liquid and sheet plates can then be exposed to curing radiation in the same manner by exposing radiation from the back side (i.e. the side which is not masked by the negative) to create a floor or support layer and by exposing to curing radiation through the negative to create the desired image. Usually, the plates are then processed to remove uncured material, e.g. by washing with water or a solvent, drying and optionally post exposing with curing radiation. Where the photopolymer composition is a liquid, the uncured liquid can be reclaimed for subsequent re-use.

Negatives can be made by a number of processes known in the art. They can be made by photographic means (e.g. using machines known as imagesetters). Imagesetters expose rolls or sheets of silver halide-coated plastic film similar to normal black & white photographic film, except the spectral sensitivity is reduced to a much narrower band to match the output of the laser in the imagesetter. Negatives can be made using lasers to selectively remove UV opaque material (typically carbon) coated onto a substrate (e.g. a polyester sheet). They can also be made by direct printing using laser or inkjet printers. Photographic film negatives created by imagesetters are monochromatic. Lasers by their nature can only be monochromatic. Typically when practising the methods of the invention with negatives obtained by photographic means or using laser removal, the shaded areas will be provided on a separate sheet to the negative. In the other hand, printers can readily deliver colour as well as monochromatic images and so the negative, including the shaded areas can be printed in a single printing process onto a single sheet. In any event, the present invention is not limited as to the method by which the negative is manufactured.

For a negative to function effectively it must achieve two objectives: it must be of satisfactory resolution to deliver the desired quality and opaque portions must be sufficiently opaque to prevent curing radiation (e.g. UV light) from passing through the areas through which it is intended that it does not pass. Negatives can be tested to see if the opaque areas stop enough radiation to be suitable for use by placing them in a densitometer, for example made by Macbeth of New Windsor, N.Y. Densitometry is the quantitative measurement of optical density and can be expressed absolutely as the amount of darkness in a given area, but usually it is a relative value, expressed in a scale. Since density is usually measured by the decrease in the amount of light which shines through a transparent film, DMax and DMin refer to the maximum and minimum density that can be recorded on the material. The translucent areas must let sufficient UV light (or other curing radiation) through unhindered. For the translucent portions (without shading) a DMin of less than 0.5 is typically acceptable. For the opaque areas, a DMax of at least 3.0 are typically considered acceptable to make a printing plate.

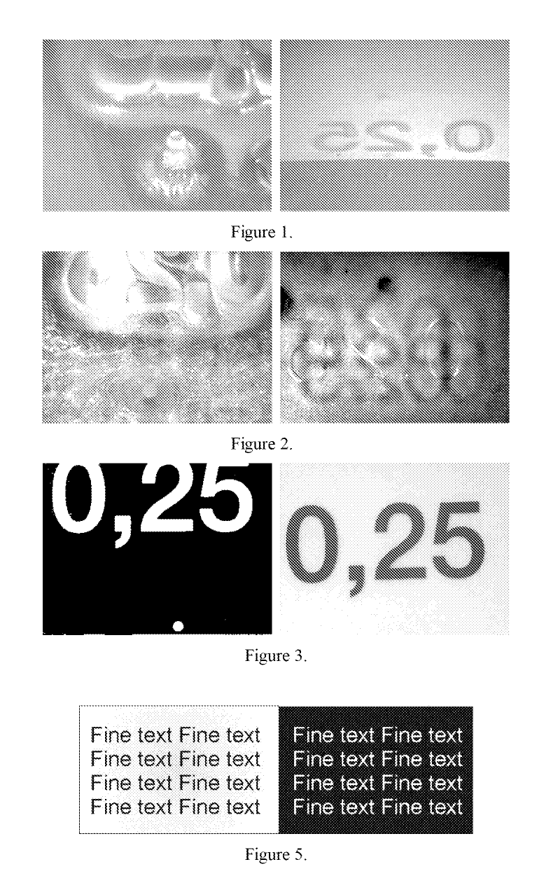

As mentioned above, this invention adjusts the transmission of UV (or other curing radiation) across the negative in relation to its design and reduces or eliminates the errors arising from overexposure of the reverse areas. A well-formed 0.25 mm reverse and a well-formed 0.25 mm diameter dot are shown in FIG. 1. In contrast an overexposed 0.25 mm dot and relief are shown in FIG. 2. The negatives which created these 0.25 mm text and relief and reverse images are shown in FIG. 3.

To investigate the effect of overexposure a set of negatives were created with increasing sizes of clear circles. They were placed in a UV exposure unit, in this case an imagebox 11 made by Photocentric of Peterborough, UK. The light transmitted through the clear circle was measured with a UV light meter directly under the centre of the circle, the results are shown in Table 1. FIG. 4 shows the increase in light transmitted being a function of the clear area on the negative.

TABLE 1

| Diameter of clear | Intensity of light |
|---|---|
| circle in negative | transmitted |
| mm | mW/cm² |
| 10 | 0.232 |
| 15 | 0.464 |
| 20 | 0.611 |
| 25 | 0.839 |
| 30 | 1.080 |
| 35 | 1.216 |
| 40 | 1.362 |
| 45 | 1.434 |
| 50 | 1.478 |
| 55 | 1.484 |
| 60 | 1.512 |
| 65 | 1.523 |
| 70 | 1.523 |
| 75 | 1.524 |
| 80 | 1.525 |

The depth of a reverse is affected by the exposure time (a variable set by the operator) and the intensity and coherence of the light (a constant for the machine) and the areas of the clear part and the black part inset inside it (a variable for the negative). Table 1 shows that the increase in the clear area of negative increases the light transmitted. This demonstrates that if the exposure time is fixed, the depth of reverse (openness) is a function of the clear area around it. This shows that for a given exposure time there are an infinite number of different depths for the reverse, from the maximum determined by geometry, downwards according to the clear areas surrounding it on the negative.

The reduction in light through the clear areas can be achieved by placing coloured masks under the monochromatic negative or more desirably by colouring the clear areas of the negative directly. It can be done with varying tones of colour or greyscale. Inkjet and laser printers can easily apply colour to the clear areas at the same time as they apply black ink in a conventional negative.

This invention creates a significant advantage for analogue plates over digital, it is now possible to achieve higher quality plates more consistently, using enhanced negatives. Digital systems can only provide one bit of information for every pixel, this invention allows many times that information to be used for every pixel, adjusting the negative artwork to deliver the intended printed image, achieving levels of consistent quality not achievable before.

A further embodiment of this invention is that the colour is not evenly distributed, but calculated at each point by calculating the amount of clear surrounding it, and adjusting the density of colour accordingly. This is shown in FIG. 5.

To investigate the effect of increasing levels of opacity in the clear reverse areas on the light transmitted, the level of yellow in a CMYK file was increased and the UV light measured through it. The coloured filter was placed in a UV exposure unit, in this case an imagebox 11 made by Photocentric of Peterborough, UK. The light transmitted through was measured with a UV light meter directly under the coloured filter.

This chart shows a linear relationship between the increase in colour and the reduction in light transmitted. Yellow colour tint was preferred to Magenta or Cyan as it stops more UV light, the clear inkjet film gave a reading of 0.31 DMax, a M=100 colour gave a DMax of 0.66, Y=100 colour gave a DMax of 0.93 and C=100 and Y=100 colour gave a DMax of 1.01.

TABLE 2

| Intensity of | | Light intensity |
|---|---|---|
| Yellow filter | DMax | transmitted |
| C = 0, M = 0, K = 0 | optical density | mW/cm² |
| Y = 0 | 31 | 1.987 |
| Y = 10 | 32 | 1.969 |
| Y = 20 | 37 | 1.732 |
| Y = 30 | 41 | 1.591 |
| Y = 40 | 46 | 1.484 |
| Y = 50 | 48 | 1.373 |
| Y = 60 | 54 | 1.246 |
| Y = 70 | 61 | 1.080 |
| Y = 80 | 66 | 0.982 |
| Y = 90 | 75 | 0.863 |
| Y = 100 | 93 | 0.683 |

The calculation for the required UV-opacity (i.e. the intensity of shading for each position) in the clear areas can be done automatically, e.g. using a computer algorithm. Thus, a computer algorithm can be written to automatically calculate the optimised light transmission at each point and selectively apply colour or grey to those areas. It does this by sequentially evaluating all of the clear parts of the negative. The algorithm leaves the smallest clear areas unchanged and selectively increases the tint in accordance with a calculation of the estimated amount of light being transmitted through the clear part at that point.

Two clear areas on a negative of the same area do not allow the same amount of light through because of the multiplying effect of light passing through at different angles of incidence. A circle emits the greatest light in proportion to its area and a line emits the least. The rate of cure of photopolymer is directly proportional to the lumens received and thus proportional to the shape, not just the area of the clear part of the negative. The centre of mass is the unique point where the weighted relative position of the distributed mass sums to zero. This algorithm looks at each clear pixel and sums all of the clear pixels adjoining it multiplied by a weighting factor applied to each position—the lower the number the further away from it they are. So a circle with all of its area as close to the centre of mass as possible will generate the largest figure for a given area. This will require the highest level of tonal shading for its area, centred in the middle, whereas the thinnest acceptable line where the area is furthest away from the centre of mass will require the least shading. The algorithm applies the darkest colour or greyscale to the centre of mass (if applicable), in a linear reduction towards the edge, radiating directly outwards to the surrounding black border. The amount of UV-blocking opacity added can be adjusted to match the level of intensity of the exposure unit.

It can be seen that any similar algorithm that selectively reduces the amount of light allowed to pass through the larger clear areas on the negative in comparison to the smaller ones is an obvious extension of this invention.

The shading in the shaded area may be composed of a plurality of dots. Thus, the colour or greyscale being applied to the translucent areas of the negative can have a half tone screen laid over them by the algorithm to increase the ink transference or Solid Ink Density (SID) of the printed image. Halftone screening is the production of dots from solid images. A regular repeated pattern is called Amplitude Modulated screening, and the screen can be described as the percentage that the area of the dots cover of the surface. So a 98% screen means that 98% of the area is covered by the surface of the dots. Other methods use stochastic functions such as Frequency Modulated screens which create the dots in non-regularly spaced arrays.

It is an accepted problem in flexographic printing that areas of solid or reverse often are inconsistent in their delivery of ink. It is known in the art that screens of 95% to 98% can produce greater SID than full 100% solids. This technique can improve the visual appearance of the printed reverse as described in U.S. Pat. No. 5,892,588 issued to Samworth, herein incorporated by reference in its entirety. These techniques have been developed further with a pattern of dots applied to the relief of a flexographic printing plate to enhance ink transference issued to Cook et al in U.S. Patent Application 2013/0017493, herein incorporated by reference in its entirety.

These screens improve ink transference in both digital and analogue systems. The half tone screen can be applied onto the solid colour already applied to the clear reverse or relief by this invention. The darker coloured dots in the half tone screen reduces the overall light transmitted in those areas, stopping more light and leading to slightly lower areas of the final printing plate which will hold more ink and consequently increase the SID.

The selective UV-blocking filter system of the invention (i.e. the selective introduction of shaded areas in the translucent portions of a negative) can also be used to level out the light in flexographic exposure units. Light from exposure units is often higher in the middle as fluorescent tubes produce lower amounts of light at the ends and the cumulative effect of rows of tubes is that the intensity of light emitted from the bulbs collates in the middle, leading to a greater intensity of light being emitted from the centre of the light source. This is particularly common in smaller exposure units. Typically designers of exposure units have to extend tubes outside the exposure area to counter this effect, creating larger and more expensive machines than would otherwise be necessary. It is easy to evaluate variation in the light emitted by an exposure unit by passing a UV meter over the surfaces and recording the results. Using the system of the invention (i.e. by selectively providing shaded areas to the translucent portions of a negative) the amount of light passing through the negative in the central higher intensity areas can be reduced to match the amount of light passing through the negative at the areas of lower intensity typically at the periphery of the plate. This would be the case for both the side of the printing plate precursor which is covered by the negative and also for the side of the printing plate precursor which is destined to become the floor or support for the printing plate which is either covered by a masking negative or left uncovered.

Thus, once the intensity levels of the UV (curing radiation) across the curing apparatus are known, the UV-blocking shaded areas can be added to every negative by the presently described algorithm thus levelling the relief. A separate screen can also be generated to level the floor.

### EXAMPLES

Various aspects of the invention will now be particularly described with reference to the following examples:

### Example 1

### Setting Optimal Exposure Time for Relief

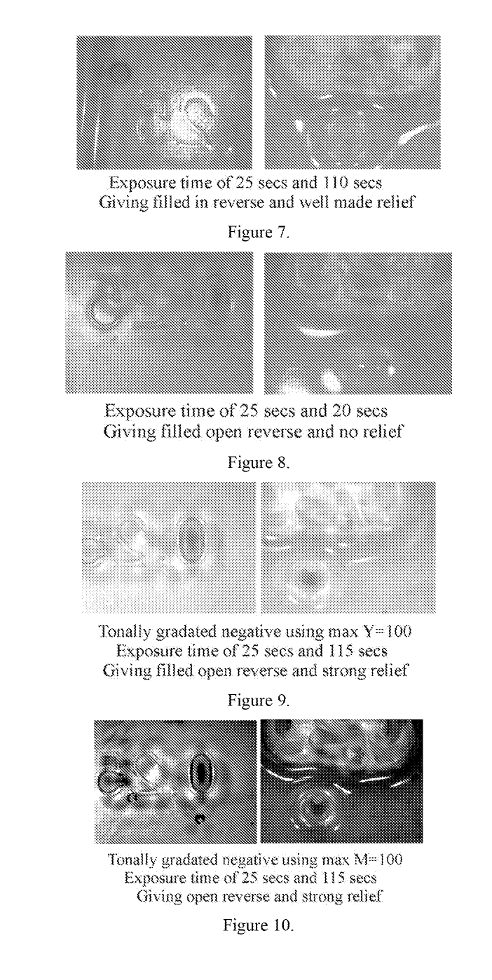

A conventional test negative made by photographic means on an imagesetter showing clear text at 0.25 mm high and a dot of the same diameter set in a black box which is juxtaposed next to the same image in black set in a clear box. This image was exposed on an imagebox 11 using i55 liquid polymer made by Photocentric. The optimal exposure time was established as the minimum time required to hold the fine 0.25 mm diameter dot. The back exposure was set to provide 60% of the final plate height, and found to be 25 secs. The main exposure was found by successive experimentation at 10 second intervals to be 110 secs. The 0.25 mm reverse shown in FIG. 7 was cut and measured and found to be 0.09 mm. The relief was formed correctly, but the reverse was closed.

### Example 2

### Setting Optimal Exposure Time for Reverse

A conventional test negative made by photographic means on an imagesetter showing clear text at 0.25 mm high and a dot of the same diameter set in a black box which is juxtaposed next to the same image in black set in a clear box. This image was exposed on an imagebox 11 using i55 liquid polymer made by Photocentric. The optimal exposure time was established as the minimum time required to just make, and hold as open as possible, the fine 0.25 mm reverse. The back exposure was set to provide 60% of the final plate height, and found to be 25 secs. The main exposure was found by successive experimentation at 10 second intervals to be 20 secs. The 0.25 mm reverse shown in FIG. 8 was cut and measured and found to be 0.23 mm. Although the reverse was open, the fine relief had not been formed at all.

### Example 3

### Using a Yellow Filter Gradated from Y=0 to Y=100 Filter on the Clear Parts of the Reverse Image to Achieve Both Strong Relief and Open Reverse

An Epson SC T-3000 printer was used with Dot Works RIP software and Photocentric imageblack inkjet film. The negative had 0.25 mm high clear text and dot of the same diameter set in a black box juxtaposed next to the same text in black in a clear box. The design was run through the algorithm to adjust the tonal colour using a Y=100 maximum additional opacity setting. The resulting file was printed and used as the negative for the plate. This image was exposed on an imagebox 11 using i55 liquid polymer both made by Photocentric. The back exposure was set to provide 60% of the final plate height, and found to be 25 secs. The main exposure was found by successive experimentation at 10 second intervals to be 125 secs. The exposure time was longer than when using imagesetter film reflecting the greater UV-blocking of the imageblack film in comparison to photographic film. The 0.25 mm reverse as shown in FIG. 9 was cut and measured and found to be 0.22 mm. The fine relief was strong and the fine reverse was open.

### Example 4

### Using a Maximum of M=100 Filter on the Clear Parts of the Reverse Image to Achieve Both Strong Relief and Open Reverse

An Epson SC T-3000 printer was used with Dot Works RIP software and Photocentric imageblack inkjet film. The negative had clear text 0.25 mm high and a dot of the same diameter set in a black box juxtaposed next to the same text in black in a clear box. The design was run through the algorithm to adjust the colour on the clear reverse using a maximum additional opacity of M=100. The resulting file was printed and used as the negative for the plate. This image was exposed on an imagebox 11 using i55 liquid polymer both made by Photocentric. The back exposure was set to provide 60% of the final plate height, and found to be 25 secs. The main exposure was found by successive experimentation at 10 second intervals to be 125 secs. The 0.25 mm reverse was cut and measured at this exposure time and found to be 0.19 mm as shown in FIG. 10. The relief was strongly made and the reverse was open.

### Example 5

### Using a Maximum of C=100 and Y=100 Filter on the Clear Parts of the Reverse to Achieve Both Strong Relief and Open Reverse

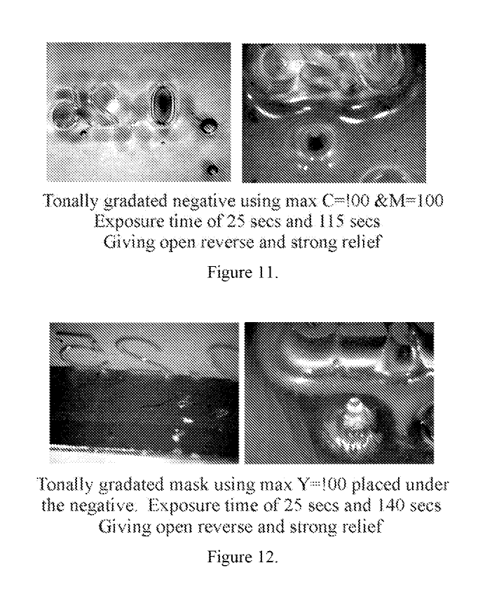

An Epson SC T-3000 printer was used with Dot Works RIP software and Photocentric imageblack inkjet film. The negative had clear 0.25 mm text and a 0.25 mm dot set in a black box juxtaposed next to the same text in black in a clear box. The design was run through the algorithm to adjust the tonal colour using a Y=100 maximum additional opacity setting. The resulting file was printed and used as the negative. This image was exposed on an imagebox 11 using i55 liquid polymer both made by Photocentric. The back exposure was set to provide 60% of the final plate height, and found to be 25 secs. The optimal exposure time for the reverse was established as the minimum time required to hold open the reverse 0.25 mm text. The main exposure was found by successive experimentation at 10 second intervals to be 125 secs. The 0.25 mm reverse was cut and measured at this exposure time and found to be 0.24 mm as shown in FIG. 11. The relief was strongly made and the reverse was widely open.

### Example 6

### Using a Separate Coloured Mask Using a Maximum of Y=100 Filter Under a Negative to Produce Strong Fine Relief and Open Reverse

An Epson SC T-3000 printer was used with Dot Works RIP software and Photocentric imageblack inkjet film to create a mask using a maximum tone of Y=100 that corresponded to the area of clear reverse on the negative. This was placed under the negative and aligned so that the shaded area of the mask was under the area of reverse on the negative. The negative had clear 0.25 mm text and a 0.25 mm dot set in a black box juxtaposed next to the same text in black in a clear box. This image was exposed on an imagebox 11 using i55 liquid polymer both made by Photocentric. The back exposure was set to provide 60% of the final plate height, and found to be 25 secs. The optimal exposure time for the reverse was established as the minimum time required to hold open the reverse 0.25 mm text. The main exposure was found by successive experimentation at 10 second intervals to be 140 secs. The 0.25 mm reverse was cut and measured at this exposure time and found to be 0.23 mm as shown in FIG. 12. The relief was strongly made and the reverse was widely open.

1. A method of making a photopolymer printing plate, comprising exposing a photopolymer composition to curing radiation through a negative comprising a translucent portion and an opaque portion, wherein the translucent portion of the negative is selectively provided with a shaded area which is not opaque but which reduces the amount of radiation that passes through to the photopolymer composition as compared to a corresponding non-shaded area to reduce or eliminate unintended exposure to curing radiation of photopolymer intended to be removed uncured.

2. A method according to claim 1, wherein the translucent portion of the negative is selectively provided with a partially radiation-blocking greyscale tint.

3. A method according to claim 1, wherein the translucent portion of the negative is selectively provided with a partially radiation-transmitting colour tint.

4. A method according to claim 1 or claim 2, wherein the negative comprises the shaded area.

5. A method according to any preceding claim, wherein the negative is produced by a laser printer.

6. A method according to any one of claims 1 to 4, wherein the negative is produced by an inkjet printer.

7. A method according to claim 1 or claim 2, wherein a film which comprises the shaded area, is positioned such that the shaded area and the negative area to be shaded overlie one another.

8. A method according to any preceding claim, wherein the shaded area is shaded to an intensity which is in proportion to their size and shape.

9. A method according to any preceding claim, wherein the photopolymer composition is in the form of a liquid.

10. A method according to any preceding claim, wherein the photopolymer composition is in the form of a sheet or a solid.

11. A method according to any preceding claim, wherein a computer algorithm calculates the intensity of shading to be applied at each point of the translucent portion of the negative in proportion to the amount of curing radiation transmitted through the negative at those points.

12. A method according to claim 10, wherein the computer algorithm also adjusts the intensity of shading according to variation in the intensity of the curing radiation transmitted from the different portions of the source of curing radiation.

13. A method according to any preceding claim, wherein the shading in the shaded area is composed of a plurality of dots.

14. A method according to any preceding claim, wherein the curing radiation is UV light.

15. A method of making a negative for use in the production of a photopolymer printing plate, wherein the negative comprises a translucent portion and an opaque portion, the method comprising selectively providing the translucent portion of the negative with a shaded area which is not opaque but which, when the negative is used in the exposure of a photopolymer composition to curing radiation, reduces the amount of radiation that passes through to the photopolymer composition as compared to a corresponding non-shaded area to reduce or eliminate unintended exposure to curing radiation of photopolymer intended to be removed uncured to form a reverse area of the printing plate.

16. A computer-implemented method of determining a shading pattern to be applied to a negative for use in the production of a photopolymer printing plate, the negative comprising translucent portions and opaque portions, wherein the method comprises scanning the negative, defining an array of pixels of predetermined size for each of the translucent portions, determining an amount of light that that will be transmitted through each pixel from a predetermined light source, and calculating a degree of shading that is to be applied to each pixel so as optimise an overall exposure of the photopolymer printing plate by the predetermined light source through the negative, the degree of shading being a function of the amount of transmitted light.

17. A method according to claim 15, wherein the degree of shading for each pixel is proportional to the amount of light determined to be transmitted through that pixel.

18. A method according to claim 15 or 16, wherein a centre of mass for each translucent portion of the negative is determined, and wherein a greater degree of shading is calculated for pixels at or close to the centre of mass than for pixels remote from the centre of mass.

19. A method according to claim 17, wherein the degree of shading required for every translucent pixel is determined by taking the sum of the products of the adjoining translucent pixels multiplied by the inverse of their distance from that pixel.

20. A computer program for instructing a computer to perform the method of any one of claims 15 to 18.

21. A negative obtainable by a method of claim 14.
